(19) United States
(12) Patent Application Publication
(10) Pub. No.: US 2025/0108562 A1
(43) Pub. Date: Apr. 3, 2025

(54) METHODS FOR STABILIZING ADDITIVELY MANUFACTURED OBJECTS

(71) Applicant: Align Technology, Inc., San Jose, CA (US)

(72) Inventors: Umesh Upendra Choudhary, Scotts Valley, CA (US); Viswanath Meenakshisundaram, Santa Clara, CA (US); Masoumeh Pourali, Mountain View, CA (US)

(21) Appl. No.: 18/902,485

(22) Filed: Sep. 30, 2024

Related U.S. Application Data
(60) Provisional application No. 63/587,246, filed on Oct. 2, 2023.

(51) Int. Cl. B29C 64/30; B29C 64/124; B29C 64/188; B29C 71/00; B29C 71/04; B29L 31/00; B33Y 10/00; B33Y 40/20; B33Y 80/00

(52) U.S. Cl. CPC B29C 64/30; B29C 64/124; B29C 64/188; B29C 71/0009; B29C 71/04; B33Y 10/00; B33Y 40/20; B33Y 80/00; B29L 2031/753

(57) ABSTRACT

Methods for stabilizing additively manufactured objects are provided. In some embodiments, a method includes fabricating an object from at least one curable material using an additive manufacturing process, where the object has a maximum thickness no greater than 5 mm. The method can include surrounding the object with a packing material, where the packing material spatially constrains the object to inhibit deformation of the object. The method can further include applying energy to the object while the object is surrounded by the packing material, where the energy alters at least one material property of the object.

### CROSS-REFERENCE TO RELATED APPLICATION(S)

The present application claims the benefit of priority to U.S. Provisional Application No. 63/587,246, filed Oct. 2, 2023, the disclosure of which is incorporated by reference herein in its entirety.

### TECHNICAL FIELD

The present technology generally relates to manufacturing, and in particular, to methods for stabilizing additively manufactured objects.

### BACKGROUND

Additive manufacturing encompasses a variety of technologies that involve building up 3D objects from multiple layers of material. For example, a polymeric object can be fabricated by selectively curing a photoreactive resin to print successive layers of the object. Thermal and curing gradients that occur during the additive manufacturing process may cause residual stresses to build up within the printed object. Moreover, post-curing of the printed object may further increase residual stresses due to different amounts of shrinkage between the surfaces of the object, which may be covered with liquid resin, and the solid cured core of the object. Annealing, which is typically used to improve the mechanical properties of the printed object, may relieve the residual stresses within the object, thus causing the object to deform. Rapid temperature fluctuations during annealing can further increase the extent of deformation due to large thermal gradients between the surfaces and core of the object. Excess deformation can cause the object to deviate from its intended geometry, which may detrimentally affect the properties and function of the object.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram providing a general overview of a method for fabricating and post-processing an additively manufactured object, in accordance with embodiments of the present technology.

FIG. 2 is a partially schematic diagram providing a general overview of an additive manufacturing process, in accordance with embodiments of the present technology.

FIGS. 3A and 3B schematically illustrate deformation of an additively manufactured object.

FIG. 4 is a flow diagram illustrating a method for manufacturing an additively manufactured object, in accordance with embodiments of the present technology.

FIG. 5A is a partially schematic illustration of an object fabricated via an additive manufacturing process, in accordance with embodiments of the present technology.

FIG. 5B is a partially schematic illustration of the object of FIG. 5A stabilized with a packing material during post-curing or annealing, in accordance with embodiments of the present technology.

FIG. 5C is a partially schematic illustration of the object of FIG. 5B after being removed from the packing material, in accordance with embodiments of the present technology.

FIG. 6A is a partially schematic illustration of an object fabricated via a first curing process, in accordance with embodiments of the present technology.

FIG. 6B is a partially schematic illustration of the object of FIG. 6A stabilized with a packing material during a second curing process, in accordance with embodiments of the present technology.

FIG. 6C is a partially schematic illustration of the object of FIG. 6B after being removed from the packing material, in accordance with embodiments of the present technology.

FIG. 7 is a flow diagram illustrating a method for manufacturing an additively manufactured object from two curable materials, in accordance with embodiments of the present technology.

FIG. 8A is a partially schematic illustration of an object including a porous structure that is fabricated from a first curable material via an additive manufacturing process, in accordance with embodiments of the present technology.

FIG. 8B is a partially schematic illustration of the object of FIG. 8A immersed in a second curable material, in accordance with embodiments of the present technology.

FIG. 8C is a partially schematic illustration of the object of FIG. 8B after removal of the second curable material from the exterior surfaces of the object, in accordance with embodiments of the present technology.

FIG. 8D is a partially schematic illustration showing the object of FIG. 8C surrounded by a packing material, in accordance with embodiments of the present technology.

FIG. 8E is a partially schematic illustration of the object of FIG. 8D after being removed from the packing material, in accordance with embodiments of the present technology.

FIG. 9A illustrates a representative example of a tooth repositioning appliance configured in accordance with embodiments of the present technology.

FIG. 9B illustrates a tooth repositioning system including a plurality of appliances, in accordance with embodiments of the present technology.

FIG. 9C illustrates a method of orthodontic treatment using a plurality of appliances, in accordance with embodiments of the present technology.

FIG. 10 illustrates a method for designing an orthodontic appliance, in accordance with embodiments of the present technology.

FIG. 11 illustrates a method for digitally planning an orthodontic treatment and/or design or fabrication of an appliance, in accordance with embodiments of the present technology.

### DETAILED DESCRIPTION

The present technology relates to manufacturing and processing of additively manufactured objects. In some embodiments, for example, a method for manufacturing an object includes fabricating an object from at least one curable material (e.g., a polymerizable resin) using an additive manufacturing process (e.g., stereolithography or digital light processing). The method can include surrounding the object with a packing material, such that the packing material spatially constrains the object to inhibit deformation of the object. For instance, the object can be placed in a chamber filled with the packing material, such that substantially all of the volume external to the object is filled with the packing material, thus preventing the object from bending, flexing, warping, swelling, etc. The method can further include applying energy to the object while the object is surrounded by the packing material, such that the energy alters at least one material property of the object. For instance, the energy can be used to cure and/or anneal the object to enhance the mechanical characteristics (e.g., modulus, elongation, strength) of the object.

The methods described herein can be used to preserve the geometry of delicate and/or thin additively manufactured objects that may otherwise be highly susceptible to deformation, such as objects having a maximum thickness no greater than 5 mm. In some embodiments, the object is a dental appliance, such as an aligner, palatal expander, retainer, etc., that has a polymeric shell configured to be worn on a patient's teeth, where the polymeric shell has a thickness within a range from 500 μm to 5 mm. The manufacturing tolerances for dental appliances can be extremely strict (e.g., no more than 50 μm), since significant deviations between the actual and intended geometry of an appliance may prevent the appliance from fitting properly on the teeth and/or result in incorrect forces being applied to the teeth.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Stabilization of Additively Manufactured Objects

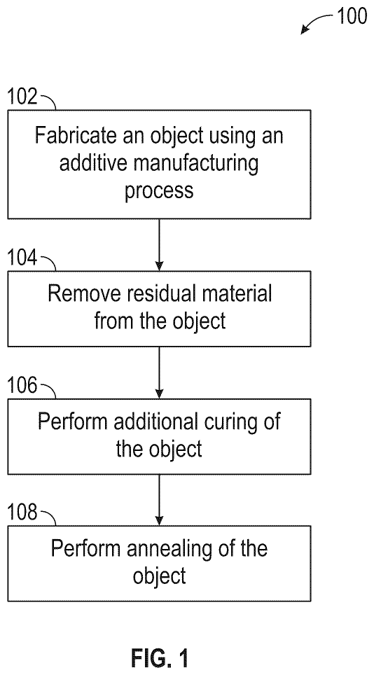

FIG. 1 is a flow diagram providing a general overview of a method 100 for fabricating and post-processing an additively manufactured object, in accordance with embodiments of the present technology. The method 100 can be used to produce many different types of additively manufactured objects, such as orthodontic appliances (e.g., aligners, palatal expanders, retainers, attachment placement devices, attachments), restorative objects (e.g., crowns, veneers, implants), and/or other dental appliances and devices (e.g., oral sleep apnea appliances, mouth guards). Additional examples of dental appliances and associated methods that are applicable to the present technology are described in Section II below.

The method 100 begins at block 102 with fabricating an object using an additive manufacturing process. Additive manufacturing (also referred to herein as “3D printing”) includes a variety of technologies which fabricate 3D objects directly from digital models through an additive process. In some embodiments, additive manufacturing includes depositing a precursor material onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

The additive manufacturing process can implement any suitable technique known to those of skill in the art. Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or reservoir of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the vat, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,624 and U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Pat. No. 10,162,264 and U.S. Patent Publication No. 2014/0265034, the disclosures of which are incorporated herein by reference in their entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., SLS) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. No. 6,749,414 and U.S. Pat. No. 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

After the additively manufactured object is fabricated, the object can undergo one or more additional process steps, also referred to herein as “post-processing.” As described in detail below with respect to blocks 104-108, post-processing can include removing residual material from the object, performing additional curing of the object, and/or performing annealing of the object.

For example, at block 104, the method 100 continues with removing residual material from the object. The residual material can include excess precursor material (e.g., uncured resin) and/or other unwanted material (e.g., debris) that remains on or within the object after the additive manufacturing process. The residual material can be removed in many different ways, such as by exposing the object to a solvent (e.g., via spraying, immersion), heating or cooling the object, applying a vacuum to the object, blowing a pressurized gas onto the object, applying mechanical forces to the object (e.g., vibration, agitation, centrifugation, tumbling, brushing), and/or other suitable techniques. Optionally, the residual material can be collected and/or processed for reuse.

At block 106, the method 100 can include performing additional curing of the object. In some embodiments, the additional curing is a “post-curing” process that is used to increase the degree of curing of the object. Post-curing can be used in embodiments where the object is still in a partially cured “green” state after fabrication. For example, the energy used to fabricate the object in block 102 may only partially polymerize the precursor material forming the object. Accordingly, the post-curing step may be needed to fully cure (e.g., fully polymerize) the object to its final, usable state. Post-curing can provide various benefits, such as improving the mechanical properties (e.g., modulus, elongation to break, elongation to yield, strength, hardness) and/or temperature stability of the object. Post-curing can be performed by applying energy to the object, such as heat, light (e.g., UV light, visible light), microwaves, etc., to the object, or suitable combinations thereof. The energy used to post-cure the object can be the same as the energy used in the additive manufacturing process, or can be different from the energy used in the additive manufacturing process.

In some embodiments, the additional curing is the second curing process of a dual-cure process. A dual-cure process can include forming an object from at least two curing processes that are triggered by different stimuli. For instance, the object can be formed from a first curing process in which a first curable material is cured by a first applied energy (e.g., UV or visible light), and from a second curing process in which a second curable material is cured by a second, different applied energy (e.g., heat). In such embodiments, the first curing process can occur during the additive manufacturing process of block 102, and the second curing process can occur as part of the additional curing of block 106. Additional details and examples of dual-cure processes that are applicable to the present technology are provided below.

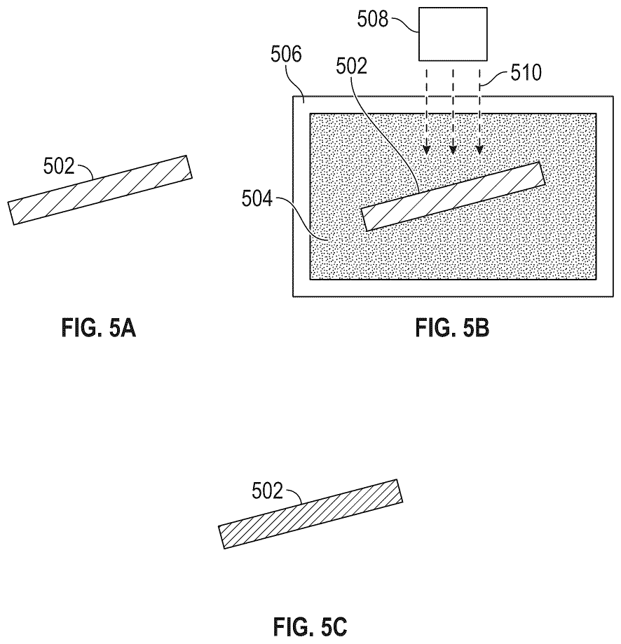

The additional curing of block 106 can be performed while the object is physically stabilized to inhibit deformation (e.g., warping, bending, swelling, shrinking) of the object. For instance, the object can be surrounded by a packing material that spatially constrains the object to prevent the object from deforming, as described further below in connection with FIGS. 4-8E.

At block 108, the method 100 can include performing annealing of the object. Annealing can improve the mechanical properties of the object, such as modulus (e.g., elastic modulus, flexural modulus, storage modulus), elongation to break, elongation to yield, strength, hardness, and/or can improve the temperature stability of the object (e.g., by increasing the glass transition temperature (T_{g}) of the object). Such improvements can result from relieving internal stresses within the object that are built up during the additive manufacturing process. For example, annealing can relieve internal stresses by causing rearrangements of the molecule structure of the object (e.g., a phase change). The annealing process can include heating the object to an elevated temperature, such as a temperature of at least 50° C., 75° C., 100° C., 125° C., 150° C., 175° C., 200° C., 225° C., or 250° C. In some embodiments, the object is heated to a temperature above the T_{g} of the object and below the melting point of the object, which may cause one or more portions of the object to undergo a phase change (e.g., from an amorphous phase to a semicrystalline or crystalline phase). Additional details and examples of annealing processes that are applicable to the present technology are provided below.

The annealing process of block 108 can be performed while the object is physically stabilized to inhibit deformation (e.g., warping, bending, swelling, shrinking) of the object. For instance, the object can be surrounded by a packing material that spatially constrains the object to prevent the object from deforming, as described further below in connection with FIGS. 4-8E.

The method 100 illustrated in FIG. 1 can be modified in many different ways. For example, the method 100 can include additional processes not shown in FIG. 1, such as cleaning the object (e.g., washing), separating the object from a build platform that supports the object during additive manufacturing and/or post-processing, trimming the object to remove structures that are not intended to be present in the final product (e.g., residual parts of the support structures), and/or packaging the object for shipment.

Optionally, the method 100 can include modifying at least one surface of the object. The surface modifications can be applied to some or all of the surfaces of the object (e.g., the exterior and/or interior surfaces) to alter one or more surface characteristics, such as the surface finish (e.g., roughness, waviness, lay), porosity, visual appearance (e.g., gloss, transparency, visibility of print lines), hydrophobicity, and/or chemical reactivity. In some embodiments, the surface modifications include removing material from the object, e.g., by polishing, abrading, blasting, etc. Alternatively or in combination, the surface modifications can include applying an additional material to the object. For example, the additional material can be a coating, such as a polymeric coating. The coating can be applied to one or more surfaces of the object for various purposes, including, but not limited to: providing a smooth surface finish, which can be beneficial for aesthetics and/or to improve user comfort if the object is intended to be in contact with the user's body (e.g., an orthodontic appliance worn on the teeth); coloring and/or applying other aesthetic features to the object; improving scratch resistance and/or other mechanical properties; providing antimicrobial properties; and incorporating therapeutic agents into the object for controlled release.

Moreover, although the above steps of the method 100 are described with respect to a single object, the method 100 can be used to sequentially or concurrently fabricate and post-process any suitable number of objects, such as tens, hundreds, or thousands of additively manufactured objects. As another example, the ordering of the processes shown in FIG. 1 can be varied (e.g., the process of block 108 can be performed before and/or concurrently with the processes of blocks 104 and/or 106). Some of the processes of the method 100 can be omitted, such as any of the processes of blocks 104, 106, and/or 108.

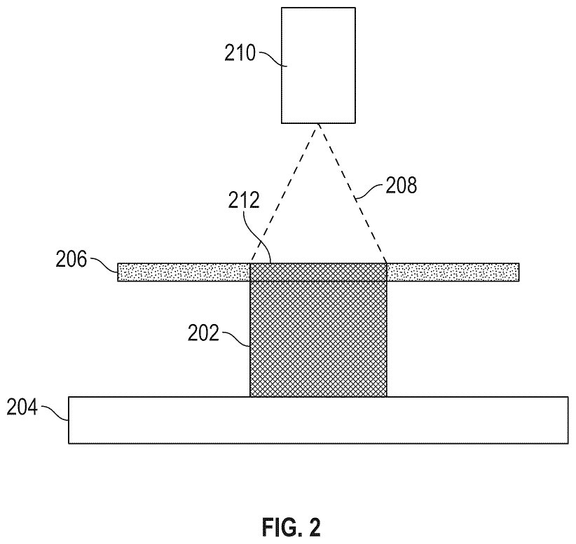

FIG. 2 is a partially schematic diagram of a representative additive manufacturing process, in accordance with embodiments of the present technology. An object 202 is fabricated on a build platform 204 from a series of cured material layers, with each layer having a geometry corresponding to a respective cross-section of the object 202. To fabricate an individual object layer, a layer of curable material 206 (e.g., polymerizable resin) is brought into contact with the build platform 204 (when fabricating the first layer of the object 202) or with the previously formed portion of the object 202 on the build platform 204 (when fabricating subsequent layers of the object 202). In some embodiments, the curable material 206 is formed on and supported by a substrate (not shown), such as a film. Energy 208 (e.g., light) from an energy source 210 (e.g., a laser, projector, or light engine) is then applied to the curable material 206 to form a cured material layer 212 on the build platform 204 or on the object 202. The remaining curable material 206 can then be moved away from the build platform 204 (e.g., by lowering the build platform 204, by moving the build platform 204 laterally, by raising the curable material 206, and/or by moving the curable material 206 laterally), thus leaving the cured material layer 212 in place on the build platform 204 and/or object 202. The fabrication process can then be repeated with a fresh layer of curable material 206 to build up the next layer of the object 202.

The illustrated embodiment shows a “top down” configuration in which the energy source 210 is positioned above and directs the energy 208 down toward the build platform 204, such that the object 202 is formed on the upper surface of the build platform 204. Accordingly, the build platform 204 can be incrementally lowered relative to the energy source 210 as successive layers of the object 202 are formed. In other embodiments, however, the additive manufacturing process of FIG. 2 can be performed using a “bottom up” configuration in which the energy source 210 is positioned below and directs the energy 208 up toward the build platform 204, such that the object 202 is formed on the lower surface of the build platform 204. Accordingly, the build platform 204 can be incrementally raised relative to the energy source 210 as successive layers of the object 202 are formed.

Although FIG. 2 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

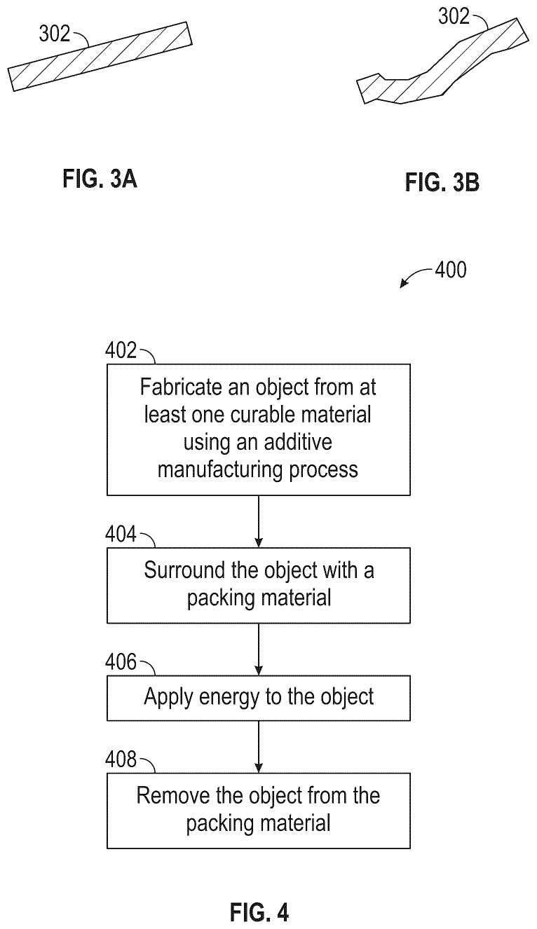

In some instances, an additively manufactured object may deform (e.g., warp, bend, swell, and/or shrink) during post-processing of the object, thus causing undesirable changes in the object geometry. For example, FIG. 3A is a schematic illustration of an object 302 having an initial geometry after the additive manufacturing process, and FIG. 3B is a schematic illustration of the object 302 having a deformed geometry after annealing.

Referring first to FIG. 3A, the object 302 can be fabricated from at least one curable material via an additive manufacturing process. In some embodiments, the additive manufacturing process involves building up the object 302 from a plurality of layers of cured material, thereby producing a layered structure. Such layer-by-layer techniques may cause different portions of the object 302 to have different thermal histories, different crystallization kinetics (e.g., if the curable material is a semicrystalline polymer such as polylactic acid (PLA), a polyamide, a polyterephthalate, etc.), and/or different curing kinetics. This may create thermal and/or curing gradients within the object 302, which may cause internal stresses to build up within the object 302 and may be detrimental to the mechanical properties of the object 302. In embodiments where the object 302 undergoes an additional curing process (e.g., post-curing or the second curing process of a dual-cure process), the stresses within the object 302 may increase, such as if different portions of the object 302 undergo different amounts of shrinkage. For instance, the surfaces of the object 302, which may be covered with residual curable material in a liquid state, may shrink differently than the core of the object 302, which may be composed primarily or entirely of solid cured material.

Referring next to FIG. 3B, annealing of the object 302 can be performed to relieve some or all of the internal stresses, thereby improving the mechanical properties. However, the annealing process can cause the object 302 to deform, such as by warping, bending, shrinking, swelling, etc. Moreover, if the temperature of the object 302 is not sufficiently controlled during the annealing process (e.g., the object 302 is heated or cooled too rapidly), thermal gradients may be created over different portions of the object 302 (e.g., the surfaces versus the core of the object 302), thus causing further deformation. Deformation may also occur during other types of post-processing operations, besides annealing. For instance, deformation can occur during post-curing and/or the second curing process of a dual-cure process if different portions of the object 302 are exposed to different amounts of curing energy, thus creating curing gradients that may cause certain object portions to shrink, swell, bend, etc., relative to other object portions. Deformation may also occur due to evaporation of volatile materials (e.g., non-reactive solvents having a low vapor pressure) that are present in the object 302 during post-processing, particularly if the object 302 is placed under vacuum. Deformation may also occur when the object 302 is exposed to solvents, e.g., during a solvent wash step to remove residual material.

The deformation of the object 302 can cause the actual geometry of the object 302 (FIG. 3B) to deviate from its initial intended geometry (FIG. 3A). Significant deviations can impair the function of the object 302 or even render the object 302 unusable. This can pose significant challenges for the additive manufacturing of objects with thin and/or small features, such as objects having a maximum thickness no greater than 5 mm. For example, the object may be a dental appliance, such as an aligner, palatal expander, retainer, etc., that has a polymeric shell configured to be worn on a patient's teeth, where the polymeric shell has a thickness within a range from 500 μm to 5 mm. The manufacturing tolerances for dental appliances can be extremely strict (e.g., no more than 50 μm), since significant deviations between the actual and intended geometry of an appliance may prevent the appliance from fitting properly on the teeth and/or result in incorrect forces being applied to the teeth.

FIG. 4 is a flow diagram illustrating a method 400 for manufacturing an additively manufactured object, in accordance with embodiments of the present technology. The method 400 can be used to reduce or prevent deformation of the object that may occur during post-processing of the object (e.g., during additional curing and/or annealing of the object). The method 400 can be combined with any of the other methods described herein, such as the method 100 of FIG. 1.

The method 400 can begin at block 402 with fabricating an object from at least one curable material using an additive manufacturing process. For example, the object can be a dental appliance, such as an aligner, palatal expander, retainer, attachment placement device, mouth guard, sleep apnea appliance, etc. Additional examples and details of dental appliances are provided in Section II below.

In some embodiments, the object is a thin part and/or has small features. For instance, the object can have a maximum thickness that is no greater than 5 mm, 2 mm, or 1 mm. The thickness of the object, which may be uniform across the entire object or may be variable across different portions of the object, can be within a range from 100 μm to 5 mm, 300 μm to 5 mm, 500 μm to 5 mm, 1 mm to 5 mm, 400 μm to 800 μm, or 500 μm to 700 μm. In embodiments where the object is an aligner or a retainer, the thickness of the object can be within a range from 350 μm to 700 μm. In embodiments where the object is a palatal expander, the thickness of the object can be within a range from 1 mm to 5 mm. The minimum feature size of the object (e.g., minimum height, width, and/or depth) can be no greater than 200 μm, 150 μm, 100 μm, or 50 μm.

The object can be made from one or more curable materials, such as a resin. The curable material can include one or more polymerizable components, such as one or more monomers, oligomers, and/or reactive polymers. The polymerizable components can be any molecule or compound capable of forming bonds with other polymerizable components, thus resulting in a larger molecule with increased molecular weight. In some embodiments, the bond-forming reaction occurs multiple times, such that the molecular weight of the resultant molecule increases with each successive bond-forming reaction. Examples of bond-forming reactions suitable for use with the techniques described herein include, but are not limited to, free radical polymerization, ionic polymerization (e.g., cationic polymerization, anionic polymerization), condensation polymerization, metathesis polymerization, Diels-Alder reactions, photodimerization, carbene formation, nitrene formation, and suitable combinations thereof.

In some embodiments, the polymerizable components include one or more of the following: an acrylate monomer, a methacrylate monomer, a thiol monomer, a vinyl acetate monomer, a vinyl ether monomer, a vinyl chloride monomer, a vinyl silane monomer, a vinyl siloxane monomer, a styrene monomer, an allyl ether monomer, an acrylonitrile monomer, a butadiene monomer, a norbornene monomer, a maleate monomer, a fumarate monomer, an epoxide monomer, an anhydride monomer, or a hydroxyl monomer. In some embodiments, the polymerizable components include one or more of the following: a free radically polymerizable group, a cationically polymerizable group, or an anionically polymerizable group. In some embodiments, the polymerizable components include one or more reactive functional groups, such as one or more of the following: an acrylate, a methacrylate, an acrylamide, a vinyl group, a vinyl ether, a thiol, an allyl ether, a norbornene, a vinyl acetate, a maleate, a fumarate, a methylenemalonate, a maleimide, an epoxide, a ring-strained cyclic ether, a ring-strained thioether, a cyclic ester, a cyclic carbonate, a cyclic silane, a cyclic siloxane, a hydroxyl, an amine, an isocyanate, a blocked isocyanate, an acid chloride, an activated ester, an oxetane, a Diels-Alder reactive group, a furan, a cyclopentadiene, an anhydride, a group favorable toward photodimerization (e.g., an anthracene, an acenaphthylene, or a coumarin), a group that photodegrades into a reactive species (e.g., Norrish Type 1 and 2 materials), an azide, a derivative thereof, or a combination thereof. Additional examples of polymerizable components that may be used are provided in U.S. Pat. No. 10,495,973 and U.S. Patent Publication Nos. 2021/0147672, 2021/0395420, 2022/0380502, and 2023/0021953, the disclosures of each of which are incorporated by reference herein in their entirety.

In some embodiments, the curable material includes one or more additives, such as catalysts (e.g., photoinitiators, thermal initiators), reaction inhibitors (e.g., photoactivated inhibitors), blockers (e.g., photoblockers), viscosity modifiers, fillers (e.g., fibers, particles), binders, reactive diluents, solvents, pigments and/or dyes, stabilizers, surface-active compounds, surfactants, mold release compounds, biologically active compounds (e.g., pharmaceuticals, enzymes, antibiotics, cells, hormones), inert polymers, inert oligomers, and/or suitable combinations thereof.

The additive manufacturing process can include selectively applying energy (e.g., heat, light) to the curable material to cause polymerization of the one or more polymerizable components, thereby curing the material to form a portion (e.g., layer) of the object. The additive manufacturing process can use any of the techniques and systems described herein, such as SLA, DLP, etc.

In some embodiments, the cured material (e.g., polymerized material) that forms the object is a nonhomogeneous material having two or more different phases. The different phases may arise from polymerization-induced phase separation of polymerizable components and/or through the use of dual-cure materials. The phases can include a first phase that is relatively rigid (e.g., a crystalline or semicrystalline phase) and a second phase that is relatively mobile (e.g., an amorphous phase). The different phases can have different T_{g} values (e.g., the T_{g} of the first, rigid phase can be higher than the T_{g} of the second, mobile phase). Objects formed from a material having two or more different phases may exhibit favorable mechanical properties, such as the ability to act quickly (e.g., vibrate quickly and react upon application of strain, from the elastic characteristics of the mobile phase) and also provide a high modulus (e.g., are stiff and provide strength, from the rigid phase). In other embodiments, however, the cured material can be a homogenous material having a single phase only (e.g., amorphous phase only, semicrystalline phase only, or crystalline phase only).

Once the additive manufacturing process is complete, the object can be subjected to one or more post-processing operations. The object may be susceptible to warping, bending, shrinking, swelling, and/or other deformations during certain types of post-processing operations, such as post-curing, the second curing process of a dual-cure process, and/or annealing, as described herein. Accordingly, the object can be physically stabilized during some or all of the post-processing operations to prevent such deformation from occurring, or to reduce the extent of any deformation that does occur.

At block 404, the method 400 can include surrounding the object with a packing material. The packing material can physically constrain the object to inhibit deformation that may otherwise occur during the subsequent processes of the method 400. For example, the packing material can contact and cover all of the surfaces of the object, thereby acting as a mechanical support that resists changes to the object geometry. In some embodiments, the object and packing material are placed in an enclosed chamber (e.g., a box, barrel, drum, tank, or other container), with the packing material filling most or all of the volume of the chamber that is external to the object (“zero free volume”). Optionally, the chamber can be hermetically sealed (e.g., airtight) so there are no residual air pockets that might otherwise allow the object to move and/or change in shape.

The packing material can be any material suitable for stabilizing the object, such as sand, diatomaceous earth, ceramic (e.g., alumina), glass, or a combination thereof. The packing material can be sufficiently durable to be reused multiple times (e.g., for at least 10 uses, 20 uses, 30 uses, 40 uses, 50 uses, 60 uses, 70 uses, 80 uses, 90 uses, or 100 uses). In some embodiments, the packing material is stable at elevated temperatures (e.g., does not degrade, soften, melt, etc.), such as a temperature of at least 50° C., 75° C., 100° C., 125° C., 150° C., 175° C., 200° C., 225° C., or 250° C. The packing material can be inert, e.g., it does not react with the curable material of the object.

In some embodiments, the packing material is in the form of a powder composed of a plurality of particles. The use of a powder-based packing material can be advantageous for conforming to irregularly-shaped object surfaces and/or filling small spaces. The particles can have any suitable size, such as an average diameter within a range from 1 μm to 1000 μm, 50 μm to 500 μm, or 500 μm to 1000 μm. The shape of the particles can also be varied as desired, e.g., the particles can be spherical, prismatic, rounded, angular, etc.

Optionally, in embodiments where the object is heated as part of post-processing, the packing material can also be used to control heat transfer to and from the object. Excessively fast heating and/or cooling of the object may create thermal gradients between the surfaces and interior of the object that may cause the object to deform, as described herein. Accordingly, the packing material can be made out of a material that is thermally conductive to allow heat transfer to and from the object, but also has a sufficiently high heat capacity to control the heating and/or cooling rate of the object to avoid creating large thermal gradients within the object.

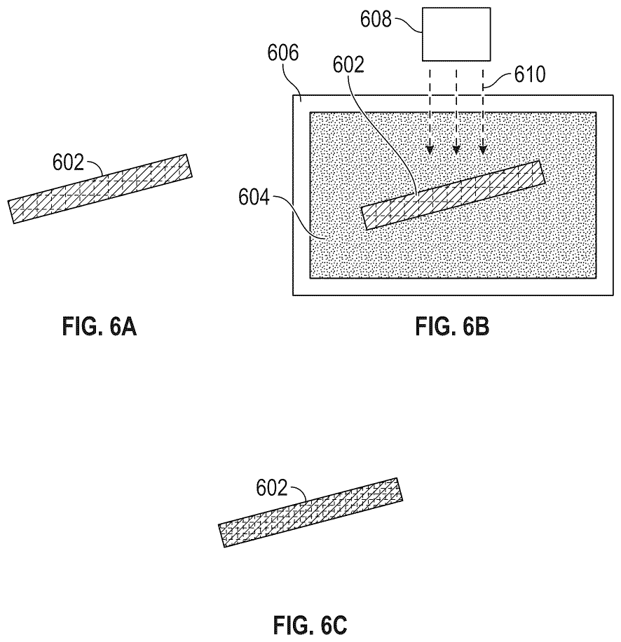

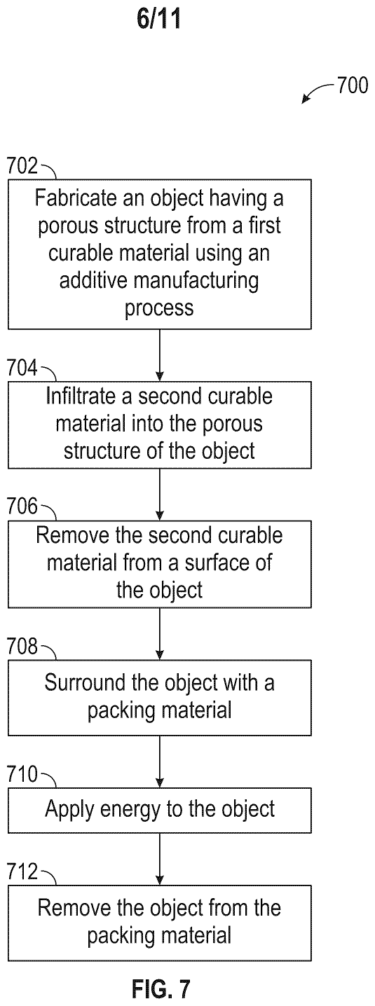

At block 406, the method 400 can include applying energy to the object. The energy can be applied as part of a post-processing operation, such as post-curing process, a second curing process of a dual-cure process, and/or an annealing process, as described further below in connection with FIGS. 5A-6C. The energy can alter at least one material property of the object, such as one or more of the following: degree of curing (e.g., degree of polymerization, double bond conversion), phase (e.g., amorphous to crystalline or semicrystalline), modulus (e.g., elastic modulus, flexural modulus), T_{g}, elongation to break, elongation to yield, strength, and/or hardness. The change in material property can occur throughout the entirety of the object, or can occur in one or more portions of the object only. For instance, the energy may be applied uniformly to the entire object, or may be targeted to selected portions of the object.

The energy used in the process of block 406 can be any type of energy suitable for triggering the change in material property (e.g., based on the particular material composition of the object), such as such as heat, light (e.g., UV light, visible light), microwaves, etc., or suitable combinations thereof. The type of energy used can be selected based on the object type, object geometry (e.g., maximum thickness), material composition of the object (e.g., type of initiator present in the object), targeted material properties for the object, type of post-processing operation (e.g., post-curing, annealing, dual-curing), type of packing material used, and/or other relevant considerations. In some embodiments, the energy is the same type of energy as the energy used in the additive manufacturing process of block 402, while in other embodiments, the energy can be different from the energy used in the additive manufacturing process of block 402. The energy can be applied using any suitable energy source, such as one or more lamps, lasers, heaters, microwave emitters, etc. In some embodiments, the energy source is located within a larger post-processing device, such as an oven, furnace, etc.

The energy can be applied to the object while the object is surrounded by the packing material. Accordingly, the packing material can mechanically stabilize the object to inhibit deformation that might otherwise occur as a result of the energy application (e.g., due to relief of internal stresses, thermal gradients and/or curing gradients), as described herein. For example, the geometry of the object before the energy is applied can be substantially the same as the geometry of the object after the energy is applied (e.g., the maximum deviation between initial and final geometry can be no more than 100 μm, 75 μm, 50 μm, 25 μm, or 10 μm).

The energy can be applied to the object for a sufficiently long time period to achieve the desired change in material properties. For instance, the object can be exposed to the energy for at least 10 minutes, 30 minutes, 1 hour, 2 hours, 5 hours, 10 hours, 12 hours, or 24 hours. The time period can be selected based on the object type, object geometry (e.g., maximum thickness), material composition of the object (e.g., type of initiator present in the object), targeted material properties for the object, type of post-processing operation (e.g., post-curing, annealing, dual-curing), type of packing material used, and/or other relevant considerations.

For example, in some embodiments, the process of block 406 involves heating the object to an elevated temperature, such as a temperature of at least 50° C., 75° C., 100° C., 125° C., 150° C., 175° C., 200° C., 225° C., or 250° C. The elevated temperature can be selected based on the type of post-processing operation. For example, in embodiments where the heating is performed as part of an annealing process, the elevated temperature can be above the T_{g} of the object and below the melting point of the object. As another example, in embodiments where the heating is performed as part of a second curing process of a dual-cure process that uses a thermal initiator, the elevated temperature can be greater than or equal to the activation temperature of the thermal initiator. In a further example, in embodiments where the heating is performed as part of a post-curing process, the elevated temperature can be configured to trigger and/or accelerate post-curing of the object.

Optionally, the heating rate can be controlled to avoid deformation caused by large thermal gradients across different portions of the object. For example, in embodiments where the object is heated in an oven or similar device, the oven temperature can be increased gradually to the elevated temperature. The heating rate can also be controlled by using a packing material having a high heat capacity, as described above.

The object can be maintained at the elevated temperature for any suitable length of time, such as at least 10 minutes, 30 minutes, 1 hour, 2 hours, 5 hours, 10 hours, 12 hours, or 24 hours. Subsequently, the object can be allowed to cool while surrounded by the packing material in order to suppress any deformation that may occur during cooling. The object can be cooled to any suitable temperature, such as room temperature (e.g., within a range from 20° C. to 25° C.). Optionally, the cooling rate can be controlled to avoid deformation caused by large thermal gradients across different portions of the object. For example, in embodiments where the object is heated in an oven or similar device, the oven temperature can be gradually decreased. The cooling rate can also be controlled by using a packing material having a high heat capacity, as described above.

At block 408, the method 400 can further include removing the object from the packing material. The object can then be subjected to further post-processing operations, such as surface modifications, cleaning the object (e.g., brushing and/or washing to remove any adhered packing material), separating the object from a build platform, trimming the object to remove support structures, and/or packaging the object for shipment.

The method 400 illustrated in FIG. 4 can be modified in many different ways. For example, the method 400 can include additional processes not shown in FIG. 4. In some embodiments, residual curable material remaining on the surfaces of the object is removed (e.g., via centrifugation, solvent washes, and/or any of the other processes described in connection with block 104 of FIG. 1) after the process of block 402 and before the process of block 404. In embodiments where the process of block 406 is performed as part of an annealing process, the method 400 can include additional curing processes before annealing, such as post-curing and/or the second curing process of a dual-cure process. In embodiments where the process of block 406 is performed as part of an additional curing process (e.g., post-curing and/or second curing) after additive manufacturing, the method 400 can include annealing the object after the process of block 406 or after the process of block 408.

Moreover, although the above steps of the method 400 are described with respect to a single object, the method 400 can be used to sequentially or concurrently fabricate and post-process any suitable number of objects, such as tens, hundreds, or thousands of additively manufactured objects. As another example, the ordering of the processes shown in FIG. 4 can be varied and/or some of the processes can be omitted.

Although the method 400 is described with respect to an object fabricated from a curable material (e.g., a resin including polymerizable components that form a thermoset polymer), in other embodiments, the method 400 can be adapted for use with other types of materials used in additive manufacturing processes. For instance, the process of block 402 can include forming the object from a thermoplastic polymer via FDM, SLS, etc.

FIGS. 5A-5C are partially schematic illustrations of a process for manufacturing an object 502, in accordance with embodiments of the present technology. The process illustrated in FIGS. 5A-5C can be performed as part of the method 400 of FIG. 4.

Referring first to FIG. 5A, the object 502 can be fabricated from a curable material (e.g., a polymerizable resin) using an additive manufacturing process, such as any of the examples described herein. For example, the additive manufacturing process can involve applying energy to the curable material to build up the object 502 from a plurality of layers of cured material. The curable material can be a resin or other composition composed of one or more polymerizable components (e.g., monomers, oligomers, reactive polymers) and, optionally, one or more additives. The polymerizable components and additives can include any of the embodiments described herein, such as any of the examples discussed in connection with block 402 of FIG. 4.

Subsequently, as shown in FIG. 5B, the object 502 can be stabilized with a packing material 504 during post-curing or annealing, in accordance with embodiments of the present technology. For instance, the object 502 can be placed within a chamber 506 (e.g., a box, barrel, drum, tank, or other container) that is filled with the packing material 504. The packing material 504 can surround the object 502 and fill the entire volume of the chamber 506 external to the object 502, thereby physically constraining the object 502 to prevent deformation, as described elsewhere herein. The chamber 506 can be placed proximate to at least one energy source 508 that outputs energy 510 toward the object 502. The energy 510 produced by the energy source 508 can pass through the chamber 506 and packing material 504 to reach the object 502. Accordingly, the chamber 506 and packing material 504 can be configured to allow the energy 510 to be transmitted to the object. For instance, in embodiments where the energy 510 is heat energy, the chamber 506 and packing material 504 can both be thermally conductive to allow the heat to reach the object 502. In some embodiments, the energy source 508 is located within a post-processing device, such as an oven, furnace, etc., and the chamber 506 is placed within the post-processing device during the energy application process.

In some embodiments, the energy 510 is applied to the object 502 as part of a post-curing process. In such embodiments, the cured material of the object 502 is initially in a partially-cured green state after additive manufacturing, and the energy 510 can further increase the degree of curing of the material.

In some embodiments, the energy 510 is applied to the object 502 as part of an annealing process. In such embodiments, the object 502 can include one or more portions that are in a first phase, and the energy 510 can cause the one or more portions to change to a second, different phase (e.g., from an amorphous phase to a semicrystalline or crystalline phase, from a semicrystalline phase to a crystalline phase). Optionally, the object 502 can be made out of a nonhomogenous material having two or more different phases, such as a rigid phase (e.g., a crystalline or semicrystalline phase having a high T_{g}) and a mobile phase (e.g., an amorphous phase having a low T_{g}). The energy 510 can cause the mobile phase to rearrange to relieve internal stresses within the object 502, while the rigid phase may remain substantially unaffected to maintain the overall shape of the object 502.

Referring next to FIG. 5C, after post-curing or annealing, the object 502 can be removed from the packing material 504. The geometry of the object 502 after post-curing or annealing can be substantially the same as the initial geometry of the object 502. In some situations, the object 502 may exhibit isotropic shrinkage, but the shape of the object 502 is still maintained (e.g., the object does not bend or otherwise warp).

FIGS. 6A-6C are partially schematic illustrations of a process for manufacturing an object 602, in accordance with embodiments of the present technology. The process illustrated in FIGS. 6A-6C can be performed as part of the method 400 of FIG. 4.

In the illustrated embodiment, the object 602 is formed from a dual-cure material including a first curable material and a second curable material. The first curable material can be cured in a first curing process using first energy, and the second curable material can be cured in a second, subsequent curing process using second energy. The second energy can be different from the first energy. For instance the second energy can be a different type of energy than the first energy (e.g., heat versus light), and/or can have different characteristics than the first energy (e.g., a different wavelength). In some embodiments, the first curable material does not cure when exposed to the second energy, and the second curable material does not cure when exposed to the first energy. Alternatively, some curing of the first or second curable material may occur when exposed to the second or first energy, respectively, but not to a sufficient degree to cause the material to solidify.

The first curable material can include a first set of one or more polymerizable components (e.g., monomers, oligomers, reactive polymers) that polymerize in response to the first energy). Similarly, the second curable material can include a second set of one or more polymerizable components (e.g., monomers, oligomers, reactive polymers) that polymerize in response to the second energy. Optionally, the first curable material can be a first functional group of a polymer that reacts with a material (e.g., a first infiltrant) in response to the first energy, and the second curable material can be a second functional group of the polymer that reacts with a material (e.g., a second infiltrant, which may or may not be the same as the first infiltrant) in response to the second energy. Examples of dual-cure materials that can be used in the present technology include urethane-epoxy composite resins.

The dual-cure material can optionally include one or more additives, such as catalysts (e.g., photoinitiators, thermal initiators), reaction inhibitors (e.g., photoactivated inhibitors), blockers (e.g., photoblockers), viscosity modifiers, fillers (e.g., fibers, particles), binders, reactive diluents, solvents, pigments and/or dyes, stabilizers, surface-active compounds, surfactants, mold release compounds, biologically active compounds (e.g., pharmaceuticals, enzymes, antibiotics, cells, hormones), inert polymers, inert oligomers, and/or suitable combinations thereof. For instance, the dual-cure material can include a first initiator (e.g., a photoinitiator) that is activated by the first energy to trigger the polymerization reaction of the first curable material, and a second initiator (e.g., a thermal initiator) that is activated by the second energy to trigger the polymerization reaction of the second curable material.

Referring first to FIG. 6A, the initial geometry of the object 602 can be formed in a first curing process in which the first curable material of the dual-cure material is cured by exposure to the first energy, thereby forming a matrix of first cured material that defines the overall geometry of the object 602. The first curing process can be part of an additive manufacturing process (e.g., SLA or DLP), as described herein. The second curable material can be present in the object 602 (e.g., retained within the matrix of the first cured material), but can remain in a substantially uncured state (e.g., as a viscous liquid).

Subsequently, as shown in FIG. 6B, the object 602 can be stabilized with a packing material 604. In the illustrated embodiment, the object 602 is placed within a chamber 606 (e.g., a box, barrel, drum, tank, or other container) that is filled with the packing material 604. The chamber 606 can be placed proximate to at least one energy source 608 that outputs the second energy 610 toward the object 602. The configuration of the packing material 604, chamber 606, and energy source 608 can be identical or generally similar to the corresponding components described in connection with FIGS. 5A-5C.

The second energy 610 can then be applied to the object 602 in a second curing process to cure the second curable material of the dual-cure material, thereby forming a second cured material that is interpenetrated with the matrix of the first cured material. The packing material 604 can constrain the object 602 during the second curing process to inhibit deformation that might otherwise occur, e.g., due to thermal and/or curing gradients within the object 602. The resulting object 602 can be a composite material including both the first and second cured materials, such that the properties of the object 602 (e.g., modulus, T_{g}, elongation to break, elongation to yield, strength, hardness) include contributions from both materials.

Referring next to FIG. 6C, after the second curing process, the object 602 can be removed from the packing material 604. The geometry of the object 602 after the second curing process can be substantially the same as the initial geometry of the object 602. In some situations, the object 602 may exhibit isotropic shrinkage, but the shape of the object 602 is still maintained (e.g., the object does not bend or otherwise warp).

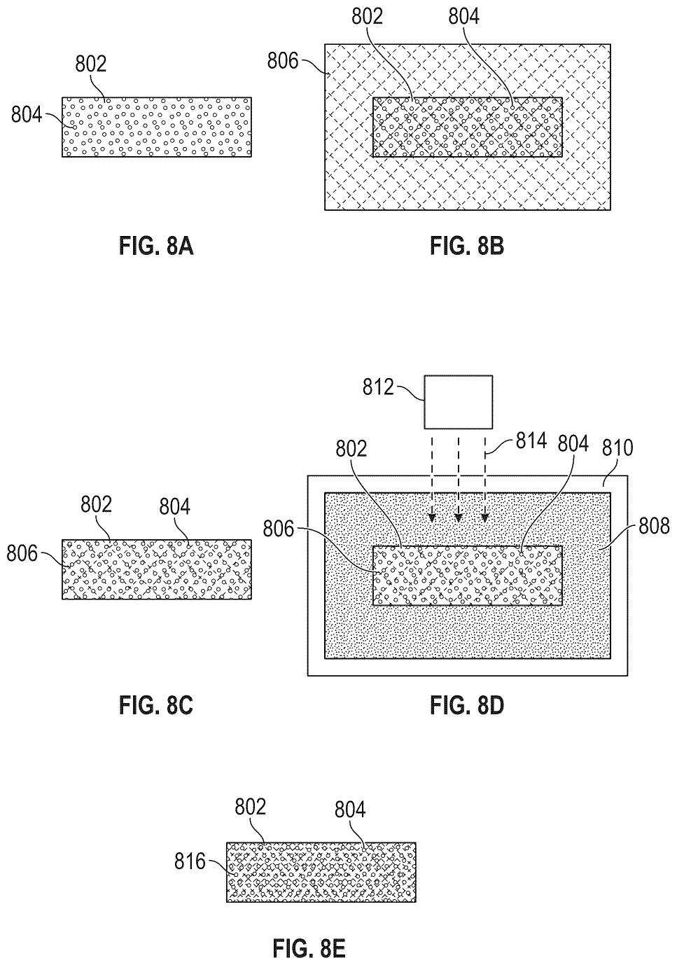

FIG. 7 is a flow diagram illustrating a method 700 for manufacturing an additively manufactured object from two curable materials, in accordance with embodiments of the present technology. The method 700 can be used to reduce or prevent deformation of the object that may occur during post-processing of the object. The method 700 can be combined with any of the other methods described herein, such as the method 100 of FIG. 1 and/or the method 400 of FIG. 4.

The method 700 can begin at block 702 with fabricating an object having a porous structure from a first curable material using an additive manufacturing process. In some embodiments, the object is a dental appliance, such as an aligner, palatal expander, retainer, attachment placement device, mouth guard, sleep apnea appliance, etc. The object can be an item that is relatively thin and/or has small features, as described above in connection with block 402 of FIG. 4.

The first curable material can be a resin or other composition composed of one or more polymerizable components (e.g., monomers, oligomers, reactive polymers) and, optionally, one or more additives. The polymerizable components and additives can include any of the embodiments described herein, such as any of the examples discussed in connection with block 402 of FIG. 4. The additive manufacturing process can include selectively applying energy (e.g., heat, light) to the first curable material to cause polymerization of the one or more polymerizable components, thereby curing the material to form a portion (e.g., layer) of the object. The additive manufacturing process can use any of the techniques and systems described herein, such as SLA, DLP, etc. In some embodiments, the first curable material is the only curable material that is present during the first curing process.

The porous structure of the object can be a mesh, sponge, foam, matrix, porous polymer network, or any other architecture having a plurality of pores that allow a second curable material to infiltrate into the object, as discussed further below. The pores can have a diameter within a range from 500 nm to 1 μm, 1 μm to 10 μm, 10 μm to 100 μm, 100 μm to 500 μm, 500 μm to 1 mm, or greater than 1 mm, for example. In some embodiments, the porous structure constitutes the entire object, while in other embodiments, the porous structure can be localized to certain portions of the object. The porous structure can be formed from the first curable material via the additive manufacturing process, e.g., in a layer-by-layer manner.

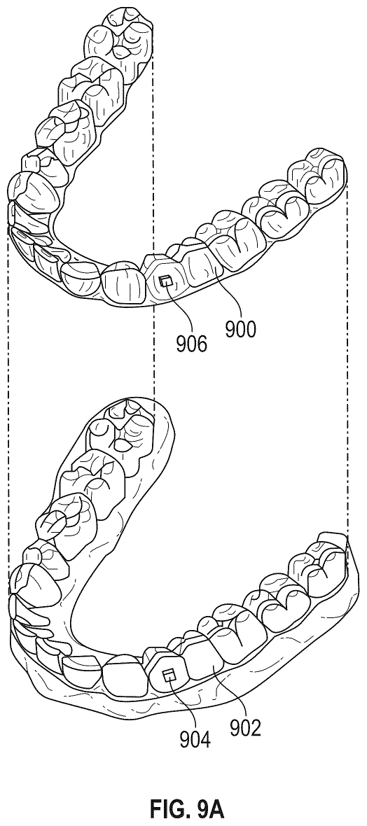

For example, FIG. 8A is a partially schematic illustration of an object 802 including a plurality of pores 804. The object 802 can be formed in a first curing process in which a first curable material is cured using first energy (e.g., light), thereby forming a porous matrix of first cured material that defines the overall geometry of the object 802.

Referring again to FIG. 7, at block 704, the method 700 can include infiltrating a second curable material into the porous structure of the object. The second curable material can be a resin or other liquid that is sufficiently flowable to enter into the pores of the object, but sufficiently viscous to remain within the porous structure even when uncured. The second curable material can be composed of one or more polymerizable components (e.g., monomers, oligomers, reactive polymers) and, optionally, one or more additives. The polymerizable components and additives can include any of the embodiments described herein, such as any of the examples discussed in connection with block 402 of FIG. 4. The second curable material can be the same as the first curable material (e.g., can include the same polymerizable components and additives), or can be different from the first curable material (e.g., can include different polymerizable components and/or additives). The second curable material can use any suitable reaction chemistry, such as isocyanate chemistry, thiol-ene chemistry, epoxy transesterification, and combinations thereof.

For example, FIG. 8B is a partially schematic illustration of the object 802 immersed into a volume of a second curable material 806. The second curable material 806 can infiltrate into the object 802 via the pores 804. The infiltration can optionally be enhanced by heating the second curable material 806 to temporarily reduce its viscosity; using vacuum, stirring, agitation, and/or other mechanical techniques to increase flow of the second curable material 806 into the pores 804 of the object 802; or suitable combinations thereof.

Referring again to FIG. 7, at block 706, the method 700 can include removing the second curable material from at least one surface of the object (e.g., some or all of the external surfaces of the object). Removal of the second curable material can be advantageous, for example, to maintain the exterior geometry of the object as defined by the matrix of first cured material and/or to avoid undesirable changes in the thickness of the object. The second curable material can be removed in many different ways, such as by exposing the object to a solvent (e.g., via spraying, immersion), heating or cooling the object, applying a vacuum to the object, blowing a pressurized gas onto the object, applying mechanical forces to the object (e.g., vibration, agitation, centrifugation, tumbling, brushing), and/or other suitable techniques. The removal technique can be selected so that the second curable material that has infiltrated into the interior of the object is not removed and remains within the porous structure. In other embodiments, however, the removal process of block 706 is optional and can be omitted.

For example, FIG. 8C is a partially schematic illustration of the object 802 after removal of the second curable material 806 from the exterior surfaces of the object 802. As shown in FIG. 8C, the second curable material 806 is retained within the pores 804 of the object 802 and thus is still present within the interior of the object 802.

Referring again to FIG. 7, at block 708, the method 700 can include surrounding the object with a packing material. The packing material can physically constrain the object to inhibit deformation that may otherwise occur during the subsequent processes of the method 700. For example, the packing material can contact and cover all of the surfaces of the object, thereby acting as a mechanical support that resists changes to the object geometry. The process of block 708 can be generally similar to the process of block 404 of FIG. 4, such that the packing materials described in connection with block 404 are also applicable to the process of block 708.

For example, FIG. 8D is a partially schematic illustration showing the object 802 surrounded by a packing material 808. In the illustrated embodiment, the object 802 is placed within a chamber 810 (e.g., a box, barrel, drum, tank, or other container) that is filled with the packing material 808. The packing material 808 can surround the object 802 and fill the entire volume of the chamber 810 external to the object 802, thereby physically constraining the object 802 to prevent deformation, as described elsewhere herein.

Referring again to FIG. 7, at block 710, the method 700 can include applying energy to the object. The energy can be applied as part of a second curing process to cure the second curable material within the porous structure of the object, such that the resulting object has a continuous solid structure in which most or all of the pores in the first cured material are filled with a second cured material. The packing material can constrain the object during the second curing process to inhibit deformation that might otherwise occur, e.g., due to thermal and/or curing gradients within the object. The resulting object can be a composite material including both the first and second cured materials, such that the properties of the object (e.g., modulus, T_{g}, elongation to break, elongation to yield, strength, hardness) include contributions from both materials.

The energy used in the process of block 710 can be any type of energy suitable for curing the second curable material (e.g., based on the particular material composition of the object), such as such as heat, light (e.g., UV light, visible light), microwaves, etc., or suitable combinations thereof. The type of energy used can be selected based on the object type, object geometry (e.g., maximum thickness), material composition of the object (e.g., type of initiator present in the object), targeted material properties for the object, type of packing material used, and/or other relevant considerations. In some embodiments, the energy is the same type of energy as the energy used in the additive manufacturing process of block 702, while in other embodiments, the energy can be different from the energy used in the additive manufacturing process of block 702. The energy can be applied using any suitable energy source, such as one or more lamps, lasers, heaters, microwave emitters, etc.

For instance, as shown in FIG. 8D, the chamber 810 containing the object 802 and packing material 808 can be placed proximate to at least one energy source 812 that outputs energy 814 toward the object 802. The energy 814 produced by the energy source 812 can pass through the chamber 810 and packing material 808 to reach the object 802. Accordingly, the chamber 810 and packing material 808 can be configured to allow the energy 814 to be transmitted to the object. For instance, in embodiments where the energy 814 is heat energy, the chamber 810 and packing material 808 can both be thermally conductive to allow the heat to reach the object 802. In some embodiments, the energy source 812 is located within a post-processing device, such as an oven, furnace, etc., and the chamber 810 is placed within the post-processing device during the energy application process. The energy 814 can then be applied to the object 802 in a second curing process to cure the second curable material 806 present within the pores 804 of the object 802. The packing material 808 can constrain the object 802 during the second curing process to inhibit deformation that might otherwise occur.

Referring again to FIG. 7, the process of block 710 can involve applying the energy for a sufficiently long time period to achieve the desired degree of curing of the second curable material. For instance, the object can be exposed to the energy for at least 10 minutes, 30 minutes, 1 hour, 2 hours, 5 hours, 10 hours, 12 hours, or 24 hours. The time period can be selected based on the object type, object geometry (e.g., maximum thickness), material composition of the object (e.g., type of initiator present in the object), targeted material properties for the object, type of packing material used, and/or other relevant considerations.

In some embodiments, the process of block 710 involves heating the object to an elevated temperature, such as a temperature of at least 50° C., 75° C., 100° C., 125° C., 150° C., 175° C., 200° C., 225° C., or 250° C. The elevated temperature can be greater than or equal to the activation temperature of a thermal initiator that is present in the second curable material. Optionally, the heating rate can be controlled to avoid deformation caused by large thermal gradients across different portions of the object, e.g., by gradually increasing the temperature and/or using a packing material having a high heat capacity, as described elsewhere herein.

The object can be maintained at the elevated temperature for any suitable length of time, such as at least 10 minutes, 30 minutes, 1 hour, 2 hours, 5 hours, 10 hours, 12 hours, or 24 hours. Subsequently, the object can be allowed to cool while surrounded by the packing material in order to suppress any deformation that may occur during cooling. The object can be cooled to any suitable temperature, such as room temperature (e.g., within a range from 20° C. to 25° C.). Optionally, the cooling rate can be controlled to avoid deformation caused by large thermal gradients across different portions of the object, e.g., by gradually decreasing the temperature and/or using a packing material having a high heat capacity, as described elsewhere herein.

At block 712, the method 700 can include removing the object from the packing material. The object can then be subjected to further post-processing operations, such as surface modifications, cleaning the object (e.g., brushing and/or washing to remove any adhered packing material), separating the object from a build platform, trimming the object to remove support structures, and/or packaging the object for shipment.

For example, as shown in FIG. 8E, after the second curing process, the object 802 can be removed from the packing material 808. The geometry of the object 802 after the second curing process can be substantially the same as the initial geometry of the object 802 after additive manufacturing, except that the pores 804 are now filled with a solid second cured material 816. The use of a second curable material 806 that fills and solidifies within the pores 804 of the object 802 may be advantageous for preventing isotropic shrinkage of the object 802.

The method 700 illustrated in FIG. 7 can be modified in many different ways. For example, the method 700 can include additional processes not shown in FIG. 7. In some embodiments, residual first curable material remaining on the surfaces of the object after additive manufacturing is removed (e.g., via centrifugation, solvent washes, and/or any of the other processes described in connection with block 104 of FIG. 1) after the process of block 702 and before the process of block 704. Moreover, the method 700 can include post-curing and/or annealing the object, e.g., after the process of block 710 or block 712. The ordering of the processes shown in FIG. 7 can be varied and/or some of the processes can be omitted (e.g., the process of block 706).

Although the above steps of the method 700 are described with respect to a single object, the method 700 can be used to sequentially or concurrently fabricate and post-process any suitable number of objects, such as tens, hundreds, or thousands of additively manufactured objects.

Additionally, although the process of block 702 is described with respect to an object fabricated from a first curable material (e.g., a resin including polymerizable components that form a thermoset polymer), in other embodiments, the method 700 can be adapted for use with other types of materials used in additive manufacturing processes. For instance, the process of block 702 can include forming the object from a thermoplastic polymer via FDM, SLS, etc.

In some embodiments, an additively manufactured object is stabilized with a packing material during a solvent wash process, e.g., for removing residual material (such as unreacted monomers) from the object. The solvent wash process may be performed at any suitable time during post-processing of the object, such as after post-curing of the object and/or before annealing of the object. The object can remain within the packing material during the solvent wash so as to inhibit deformation of the object due to exposure to the solvent. In such embodiments, the object and packing material can be immersed in the solvent (e.g., in a solvent bath), the solvent can infiltrate into the packing material to reach the object, and residual material on the object can be solubilized in the solvent. The packing material can be sufficiently porous and/or permeable to the solvent to allow the solvent to access the object. Optionally, the solvent may be stirred, flowed, sonicated, or otherwise agitated to enhance infiltration of the solvent into the packing material.

### II. Dental Appliances and Associated Methods

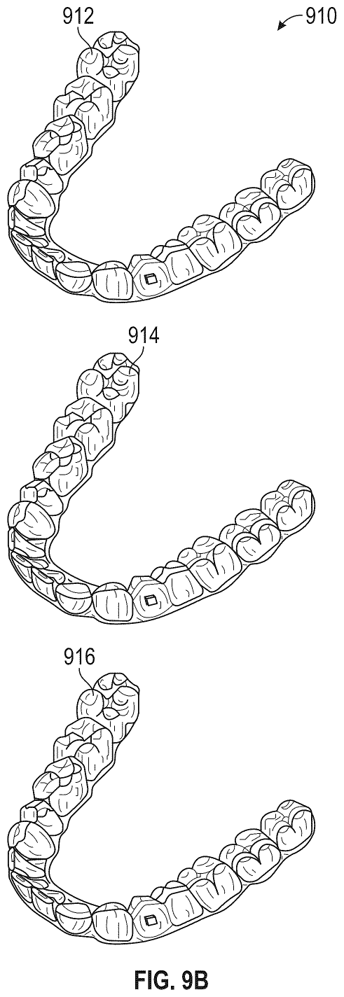

FIG. 9A illustrates a representative example of a tooth repositioning appliance 900 configured in accordance with embodiments of the present technology. The appliance 900 can be manufactured and post-processed using any of the systems, methods, and devices described herein. The appliance 900 (also referred to herein as an “aligner”) can be worn by a patient in order to achieve an incremental repositioning of individual teeth 902 in the jaw. The appliance 900 can include a shell (e.g., a continuous polymeric shell or a segmented shell) having teeth-receiving cavities that receive and resiliently reposition the teeth. The appliance 900 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 900 can fit over all teeth present in an upper or lower jaw, or less than all of the teeth. The appliance 900 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 900 can be a generic appliance configured to receive the teeth, but not necessarily shaped to match the topography of the patient's teeth. In some cases, only certain teeth received by the appliance 900 are repositioned by the appliance 900 while other teeth can provide a base or anchor region for holding the appliance 900 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 900 in place over the teeth. In some cases, however, it may be desirable or necessary to provide individual attachments 904 or other anchoring elements on teeth 902 with corresponding receptacles 906 or apertures in the appliance 900 so that the appliance 900 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 9B illustrates a tooth repositioning system 910 including a plurality of appliances 912, 914, 916, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 910 can include a first appliance 912 corresponding to an initial tooth arrangement, one or more intermediate appliances 914 corresponding to one or more intermediate arrangements, and a final appliance 916 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 9C illustrates a method 920 of orthodontic treatment using a plurality of appliances, in accordance with embodiments of the present technology. The method 920 can be practiced using any of the appliances or appliance sets described herein. In block 922, a first orthodontic appliance is applied to a patient's teeth in order to reposition the teeth from a first tooth arrangement to a second tooth arrangement. In block 924, a second orthodontic appliance is applied to the patient's teeth in order to reposition the teeth from the second tooth arrangement to a third tooth arrangement. The method 920 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

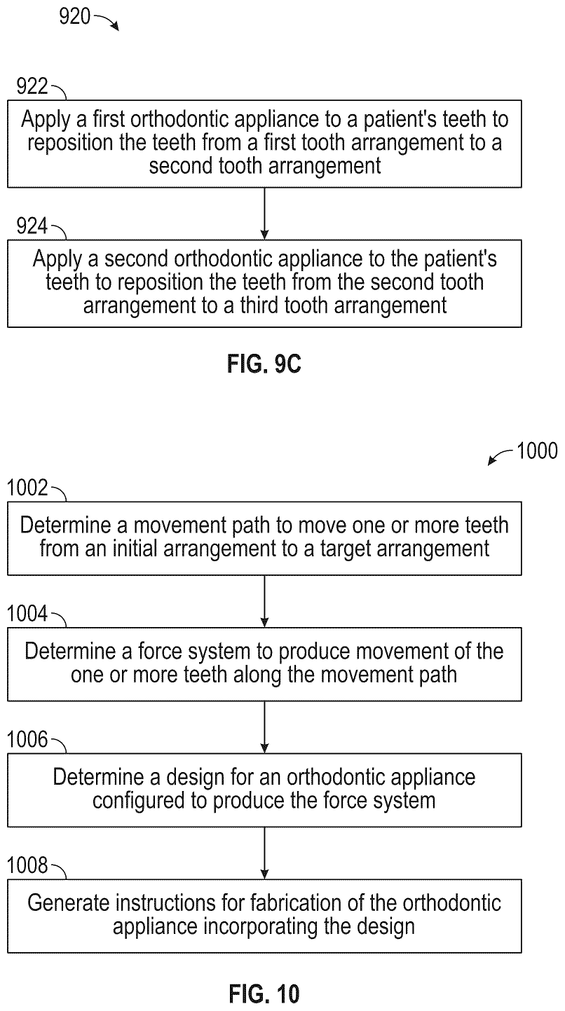

FIG. 10 illustrates a method 1000 for designing an orthodontic appliance, in accordance with embodiments of the present technology. The method 1000 can be applied to any embodiment of the orthodontic appliances described herein. Some or all of the steps of the method 1000 can be performed by any suitable data processing system or device, e.g., one or more processors configured with suitable instructions.

In block 1002, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1004, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1004 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1006, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1008, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1000 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1000 may be performed with any suitable fabrication system or device, such as the embodiments described herein. Some of the steps may be optional, e.g., the process of block 1004 can be omitted, such that the orthodontic appliance is designed based on the desired tooth movements and/or determined tooth movement path, rather than based on a force system. Moreover, the order of the steps can be varied as desired.

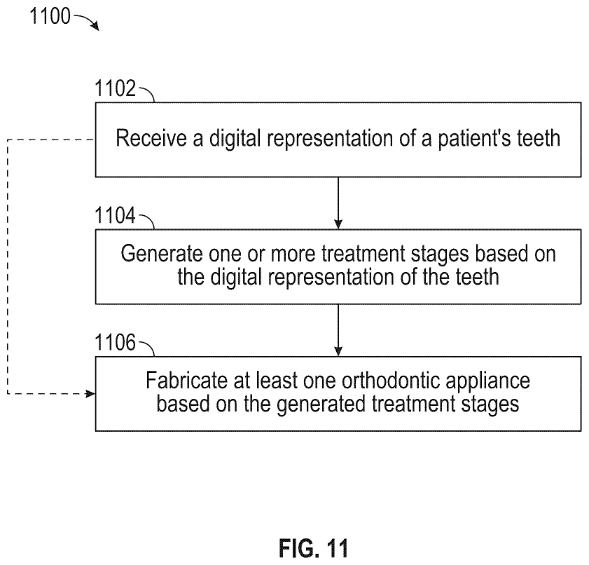

FIG. 11 illustrates a method 1100 for digitally planning an orthodontic treatment and/or design or fabrication of an appliance, in accordance with embodiments. The method 1100 can be applied to any of the treatment procedures described herein and can be performed by any suitable data processing system.

In block 1102 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1104, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1106, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 11, design and/or fabrication of an orthodontic appliance, and perhaps a particular orthodontic treatment, may include use of a representation of the patient's teeth (e.g., including receiving a digital representation of the patient's teeth (block 1102)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A method comprising:
fabricating an object from at least one curable material using an additive manufacturing process, wherein the object has a maximum thickness no greater than 5 mm;
surrounding the object with a packing material, wherein the packing material spatially constrains the object to inhibit deformation of the object; and
applying energy to the object while the object is surrounded by the packing material, wherein the energy alters at least one material property of the object.

Example 2. The method of Example 1, wherein the additive manufacturing process comprises stereolithography or digital light processing.

Example 3. The method of Example 1 or 2, wherein the additive manufacturing process comprises applying energy to the at least one curable material to form a plurality of cured material layers.

Example 4. The method of Example 3, wherein the energy used in the additive manufacturing process is different from the applied energy that alters the at least one material property of the object.

Example 5. The method of Example 3, wherein the energy used in the additive manufacturing process is the same as the applied energy that alters the at least one material property of the object.

Example 6. The method of any one of Examples 1 to 5, wherein the at least one curable material comprises a polymerizable resin.

Example 7. The method of any one of Examples 1 to 6, wherein the object comprises a mobile phase and a rigid phase that are formed from the at least one curable material.

Example 8. The method of any one of Examples 1 to 7, wherein the at least one material property comprises one or more of the following: degree of curing of the object, phase, modulus, glass transition temperature (T_{g}), elongation to break, elongation to yield, strength, or hardness.

Example 9. The method of any one of Examples 1 to 8, wherein the applied energy causes annealing of the object.

Example 10. The method of any one of Examples 1 to 8, wherein the applied energy causes post-curing of the object.

Example 11. The method of any one of Examples 1 to 10, wherein the object comprises a first region having a first T_{g}, and a second region having a second T_{g} different from the first T_{g}, and wherein the applied energy causes rearrangement of at least one of the first or second regions within the object.

Example 12. The method of any one of Examples 1 to 11, wherein:
the at least one curable material comprises a first curable material and a second curable material,
the additive manufacturing process comprises a first curing process to cure the first curable material, and
the energy is applied as part of a second curing process to cure the second curable material.

Example 13. The method of Example 12, wherein the second curable material is not substantially cured during the first curing process.

Example 14. The method of any one of Examples 1 to 11, wherein:
the at least one curable material comprises a first curable material and the additive manufacturing process comprises a first curing process to cure the first curable material to form a porous structure,
the method further comprises infiltrating a second curable material into the porous structure, and
the energy is applied as part of a second curing process to cure the second curable material within the porous structure.

Example 15. The method of any one of Examples 1 to 14, wherein applying the energy comprises heating the object.

Example 16. The method of Example 15, wherein the packing material is configured to transfer heat to the object.

Example 17. The method of Example 15 or 16, further comprising cooling the object while the object is surrounded by the packing material.

Example 18. The method of any one of Examples 1 to 17, further comprising exposing the object to a solvent while the object is surrounded by the packing material to remove residual curable material from the object.

Example 19. The method of any one of Examples 1 to 18, wherein the packing material comprises a plurality of particles.

Example 20. The method of any one of Examples 1 to 19, wherein the packing material comprises a high heat capacity material.

Example 21. The method of any one of Examples 1 to 20, wherein the packing material comprises one or more of the following: sand, diatomaceous earth, ceramic, or glass.

Example 22. The method of any one of Examples 1 to 21, wherein the packing material and the object are enclosed within a chamber during the applying of the energy.

Example 23. The method of Example 22, wherein the chamber is hermetically sealed.

Example 24. The method of any one of Examples 1 to 23, wherein the maximum thickness is no greater than 2 mm.

Example 25. The method of Example 24, wherein the maximum thickness is no greater than 1 mm.

Example 26. The method of any one of Examples 1 to 25, wherein the object has a first geometry after the additive manufacturing process, and a second geometry after the application of the energy, and a maximum deviation between the first and second geometries is no greater than 200 μm.

Example 27. The method of Example 26, wherein the maximum deviation is no greater than 50 μm.

Example 28. The method of any one of Examples 1 to 27, wherein the object is a dental appliance.

Example 29. A system for manufacturing an object, the system comprising:
an additive manufacturing system comprising:
   a source of at least one curable material, and
   a first energy source configured to apply first energy to the at least one curable material to fabricate an object according to an additive manufacturing process; and
a post-processing system comprising:
   a chamber containing a packing material configured to surround and spatially constrain the object to inhibit deformation of the object, and
   a second energy source configured to apply second energy to the object to alter at least one material property of the object.

Example 30. The system of Example 29, wherein the additive manufacturing process comprises stereolithography or digital light processing.

Example 31. The system of Example 29 or 30, wherein the first energy source is configured to apply the first energy to the at least one curable material to form a plurality of cured material layers.

Example 32. The system of any one of Examples 29 to 31, wherein the first energy is different from the second energy.

Example 33. The system of any one of Examples 29 to 31, wherein the first energy is the same as the second energy.

Example 34. The system of any one of Examples 29 to 33, wherein the at least one curable material comprises a polymerizable resin.

Example 35. The system of any one of Examples 30 to 34, wherein the object comprises a mobile phase and a rigid phase that are formed from the at least one curable material.

Example 36. The system of any one of Examples 29 to 35, wherein the at least one material property comprises one or more of the following: degree of curing of the object, phase, modulus, glass transition temperature (T_{g}), elongation to break, elongation to yield, strength, or hardness.

Example 37. The system of any one of Examples 29 to 36, wherein the second energy causes annealing of the object.

Example 38. The system of any one of Examples 29 to 36, wherein the second energy causes post-curing of the object.

Example 39. The system of any one of Examples 29 to 38, wherein the object comprises a first region having a first T_{g}, and a second region having a second T_{g} different from the first T_{g}, and wherein the second energy causes rearrangement of at least one of the first or second regions within the object.

Example 40. The system of any one of Examples 29 to 39, wherein:
the at least one curable material comprises a first curable material and a second curable material,
the additive manufacturing system is configured to perform a first curing process to cure the first curable material, and
the post-processing system is configured to perform a second curing process to cure the second curable material.

Example 41. The system of Example 40, wherein the second curable material is not substantially cured during the first curing process.

Example 42. The system of any one of Examples 29 to 39, wherein:
the at least one curable material comprises a first curable material and the additive manufacturing process comprises a first curing process to cure the first curable material to form a porous structure,
the system further comprises a source of a second curable material configured to infiltrate into the porous structure, and
the post-processing system is configured to perform a second curing process to cure the second curable material within the porous structure.

Example 43. The system of any one of Examples 29 to 42, wherein the second energy source is configured to heat the object.

Example 44. The system of Example 43, wherein the packing material is configured to transfer heat to the object.

Example 45. The system of any one of Examples 29 to 44, wherein the post-processing system further comprises a solvent source configured to expose the object to a solvent while the object is surrounded by the packing material to remove residual curable material from the object.

Example 46. The system of any one of Examples 29 to 45, wherein the packing material comprises a plurality of particles.

Example 47. The system of any one of Examples 29 to 46, wherein the packing material comprises a high heat capacity material.

Example 48. The system of any one of Examples 29 to 47, wherein the packing material comprises one or more of the following: sand, diatomaceous earth, ceramic, or glass.

Example 49. The system of any one of Examples 29 to 48, wherein the chamber is hermetically sealed.

Example 50. The system of any one of Examples 29 to 49, wherein the maximum thickness is no greater than 2 mm.

Example 51. The system of Example 50, wherein the maximum thickness is no greater than 1 mm.

Example 52. The system of any one of Examples 29 to 51, wherein the object is a dental appliance.

### Conclusion

Although many of the embodiments are described above with respect to systems, devices, and methods for manufacturing dental appliances, the technology is applicable to other applications and/or other approaches, such as manufacturing of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-11.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
fabricating an object from at least one curable material using an additive manufacturing process, wherein the object has a maximum thickness no greater than 5 mm;
surrounding the object with a packing material, wherein the packing material spatially constrains the object to inhibit deformation of the object; and
applying energy to the object while the object is surrounded by the packing material, wherein the energy alters at least one material property of the object.

2. The method of claim 1, wherein the applied energy causes annealing of the object.

3. The method of claim 1, wherein the applied energy causes post-curing of the object.

4. The method of claim 1, wherein the object comprises a first region having a first T_{g}, and a second region having a second T_{g} different from the first T_{g}, and wherein the applied energy causes rearrangement of at least one of the first or second regions within the object.

5. The method of claim 1, wherein the object comprises a mobile phase and a rigid phase that are formed from the at least one curable material.

6. The method of claim 1, wherein the at least one material property comprises one or more of the following: degree of curing of the object, phase, modulus, glass transition temperature (T_{g}), elongation to break, elongation to yield, strength, or hardness.

7. The method of claim 1, wherein:
the at least one curable material comprises a first curable material and a second curable material,
the additive manufacturing process comprises a first curing process to cure the first curable material, and
the energy is applied as part of a second curing process to cure the second curable material.

8. The method of claim 7, wherein the second curable material is not substantially cured during the first curing process.

9. The method of claim 1, wherein:
the at least one curable material comprises a first curable material and the additive manufacturing process comprises a first curing process to cure the first curable material to form a porous structure,
the method further comprises infiltrating a second curable material into the porous structure, and
the energy is applied as part of a second curing process to cure the second curable material within the porous structure.

10. The method of claim 1, wherein applying the energy comprises heating the object, and wherein the packing material is configured to transfer heat to the object.

11. The method of claim 10, further comprising cooling the object while the object is surrounded by the packing material.

12. The method of claim 1, further comprising exposing the object to a solvent while the object is surrounded by the packing material to remove residual curable material from the object.

13. The method of claim 1, wherein the packing material comprises a plurality of particles.

14. The method of claim 1, wherein the packing material comprises a high heat capacity material.

15. The method of claim 1, wherein the packing material comprises one or more of the following: sand, diatomaceous earth, ceramic, or glass.

16. The method of claim 1, wherein the packing material and the object are enclosed within a chamber during the applying of the energy.

17. The method of claim 1, wherein the object has a first geometry after the additive manufacturing process, and a second geometry after the application of the energy, and a maximum deviation between the first and second geometries is no greater than 200 μm.

18. The method of claim 1, wherein the additive manufacturing process comprises stereolithography or digital light processing.

19. The method of claim 1, wherein the at least one curable material comprises a polymerizable resin.

20. The method of claim 1, wherein the object is a dental appliance.
